(19) United States
(12) Patent Application Publication
(10) Pub. No.: US 2019/0315279 A1
(43) Pub. Date: Oct. 17, 2019

(54) Narrow Door Vehicle Sling Bag Track System

(71) Applicant: SPARTAN MOTORS, INC., CHARLOTTE, MI (US)

(72) Inventors: Richard D. Eichstedt, Walkerton, IN (US); Travis W. Elliott, Goshen, IN (US); Brian D. Demkovich, Granger, IN (US); Christopher T. Shoptaw, Granger, IN (US)

(73) Assignee: SPARTAN MOTORS, INC., CHARLOTTE, MI (US)

(21) Appl. No.: 16/384,123

(22) Filed: Apr. 15, 2019

Related U.S. Application Data
(60) Provisional application No. 62/658,664, filed on Apr. 17, 2018.

(51) Int. Cl. B60R 5/00

(52) U.S. Cl. CPC B60R 5/003

(57) ABSTRACT

A cargo vehicle is provided that includes a cargo area with a rail assembly located in the cargo area. A movable rail assembly is selectively attachable to the rail assembly in the cargo area. The movable rail assembly includes an elongated track arm. A latch assembly selectively couples to the elongated track arm. The elongated track arm aligns with the rail assembly when the latch assembly is coupled to the elongated track arm.

### RELATED APPLICATIONS

The present Application is related to and claims priority to U.S. Provisional Patent Application, Ser. No. 62/658,664, filed on Apr. 17, 2018, entitled “Narrow Door Vehicle Sling Bag Track System.” The subject matter disclosed in that Provisional Application is hereby expressly incorporated into the present Application.

### TECHNICAL FIELD AND SUMMARY

The present disclosure relates to delivery vehicles. More particularly, the present disclosure relates to a track system located in the cargo area of a delivery vehicle. The track system is extendable to the exterior of the vehicle to suspend a container over the ground surface.

Delivery vehicles typically include forward cab and rearward cargo area sections. A typical cargo area is sized to hold packages, supplies, uniforms, etc. for delivery and pickup. Such delivery vehicles are commonly used by companies as UPS, FedEx, Cintas, Aramark, G&K Services, and Unifirst, for example.

In the case of uniforms, where both clean and soiled clothes are transported in the same delivery vehicle, there may be a lack of organization and efficiency. Clean laundry can be hung on hangers suspended from a rod inside the delivery vehicle. Soiled laundry may be piled on the floor. The soiled laundry on the floor can be problematic if piled too high because it then has to be crawled over in order to access the hanging clean laundry. Furthermore, soiled laundry needs sorting. Pants, shirts, whites, food whites, permanent press, and jackets need to be separated before washing. This requires substantial manpower to unload and sort the soiled laundry into separate containers before transporting it to the laundry facilities.

A rail bag sling system has been developed to more efficiently allow laundry bags to be suspended from the interior to the exterior of the delivery vehicle. As shown in U.S. Pat. No. 8,997,656, entitled “Vehicle Sling Bag Rail System,” issued Apr. 7, 2015, and U.S. Pat. No. 9,738,207, entitled “Vehicle Sling Bag Rail System,” issued Aug. 22, 2017, the entire disclosures of both Patents are expressly incorporated herein by reference, a laundry bag may be selectively extended and hung in the exterior of the vehicle, as illustratively shown in FIGS. 1, 2, and 3 of both Patents. It is notable, however, that the illustrative delivery vehicle 1 shown in those patents have a cargo area 2 with a rear opening that extends appreciably the width of the cargo area. The doors on cargo area 2 of delivery vehicle 1 in these Patents are hinged adjacent the sidewalls of cargo area 2. This allows the rail structures as disclosed in these Patents to be located adjacent the sidewall as well. Certain delivery vehicles, however, include a rear wall at the end of the cargo area with the door or doors located within that rear wall. In other words, the doors fit into an opening that is substantially narrower than the entire rear width of the cargo area.

Accordingly, an illustrative embodiment of the present disclosure provides a cargo vehicle comprising: a cargo area that includes an internal surface; a rail assembly attached to the internal surface; and a movable rail assembly selectively attachable to the rail assembly that is attached to the internal surface of the cargo area. The movable rail assembly includes an elongated track arm and a pivot arm. The pivot arm is attached to the cargo area and selectively attachable to the elongated track. A latch assembly selectively couples to the elongated track arm of the movable rail assembly. The elongated track arm aligns with the rail assembly when the latch assembly is coupled to the elongated track arm. The track arm is extendable from the interior of the cargo area to the exterior of the cargo area.

In the above and other illustrative embodiments, the cargo vehicle may further comprise: the elongated track arm being aligned with the rail assembly at a nonlinear angle with respect to the rail assembly; the pivot arm being attachable to a second internal surface of the cargo area; the pivot arm being pivotally attached to the second internal surface of the cargo area; the pivot arm being pivotally attached to the elongated track arm; a receiver that selectively holds the pivot arm; a receiver attached to the second internal surface of the cargo area, wherein the receiver selectively holds the pivot arm adjacent the second internal surface of the cargo area; the pivot arm including a bracket that selectively attaches to the elongated track arm; the latch assembly including a rotary latch that selectively engages a pin located on the elongated track arm to align the rail assembly with the elongated track arm; the elongated track arm including a bracket that holds the pin; the cargo area including an opening, wherein the opening is located between the interior of the cargo area and the exterior of the cargo area, and wherein the elongated track arm is extendable through the opening from the interior of the cargo area to the exterior of the cargo area; and a sling bag that is suspendable on the rail assembly and movable along the interior track assembly from the interior of the cargo area to the exterior of the cargo area.

Another illustrative embodiment of the present disclosure provides a cargo vehicle comprising: a cargo area that includes a rail assembly located in the cargo area and a movable rail assembly selectively attachable to the rail assembly in the cargo area. The movable rail assembly includes an elongated track arm. A latch assembly selectively couples to the elongated track arm. The elongated track arm aligns with the rail assembly when the latch assembly is coupled to the elongated track arm.

In the above and other illustrative embodiments, the cargo vehicle may further comprise: the track arm being extendable from the interior of the cargo area to the exterior of the cargo area; the cargo area including a first wall wherein the rail assembly is attached to the first wall; a pivot arm selectively attachable to the elongated track; the pivot arm being pivotally attached to a second wall of the cargo area and pivotally and selectively attachable to the elongated track; a receiver attached to the second wall of the cargo area, wherein the receiver selectively holds the pivot arm adjacent the second wall of the cargo area; and the elongated track arm being aligned with the rail assembly at a nonlinear angle with respect to the rail assembly.

Another illustrative embodiment of the present disclosure provides a method of assembling a sling bag track system for a cargo vehicle, the method comprising the steps of: providing a cargo area portion of the cargo vehicle, wherein the cargo area includes a first wall with a rail assembly attached to the first wall, a pivot arm located within the cargo area and pivotable with respect to the first wall, a latch assembly located adjacent the rail assembly, and a second wall with an opening disposed through the second wall; inserting an elongated track arm through the opening disposed through the second wall; attaching the elongated track arm to the pivot arm; attaching the elongated track arm to the latch assembly; and extending the elongated track arm from the interior of the cargo area to the exterior of the cargo area.

Additional features and advantages of the narrow vehicle sling bag track system will become apparent to those skilled in the art upon consideration of the following detailed descriptions of carrying out the narrow vehicle sling bag track system as presently perceived.

### BRIEF DESCRIPTION OF DRAWINGS

The concepts described in the present disclosure are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels may be repeated among the figures to indicate corresponding or analogous elements.

FIG. 1 is a side view of a delivery vehicle with a laundry sling bag suspended from a narrow door vehicle sling bag track system according to the present disclosure;

FIG. 2 is a rear perspective view of the cargo area of the delivery vehicle;

FIG. 3 is a rear perspective interior view of the cargo area of the delivery vehicle with the roof removed;

FIG. 4 is another rear perspective interior view of the cargo area with the roof removed;

FIG. 5 is another rear perspective interior view of the cargo area having the roof removed;

FIG. 6 is another rear perspective interior view of the cargo area with the roof removed;

FIG. 7 is another rear perspective interior view of the cargo area with the roof removed;

FIG. 8 is another rear perspective interior view of the cargo area with the roof removed;

FIG. 9 is a top perspective interior view of the cargo area with the roof removed and looking towards the rear end of the cargo area;

FIG. 10 is a top perspective interior detail view of a portion of the cargo area from FIG. 9;

FIG. 11 is a detailed perspective view of a track end of an interior track;

FIG. 12 is a rear perspective interior view of the cargo area with the roof and doors removed showing the interior of the cargo area;

FIG. 13 is a detail view of the portion of the cargo area from FIG. 12 showing portions of a track and pivot arm;

FIG. 14 is a detailed perspective interior view of the cargo area with the roof removed;

FIG. 15 is another detail perspective view of the interior of the cargo area;

FIG. 16 is an underside perspective detail view of the interior of the cargo area depicting how the interior track couples to a tract;

FIG. 17 is a top detail view of the interior of the cargo area showing interior tracks which allow sling bags to roll along;

FIG. 18 is a reverse perspective detail view of a rotary latch assembly;

FIG. 19 is a top perspective interior view of the cargo area with the roof and doors removed;

FIG. 20 is a detail perspective interior view of the cargo area with the roof removed;

FIG. 21 is another perspective interior view of the interior of the cargo area with the roof and doors removed;

FIG. 22A is a front view of a trolley;

FIG. 22B is a side view of the trolley of FIG. 22A;

FIG. 23 is a perspective isolated view of a sling bag hanging from an interior track;

FIG. 24A is an end detail view of the sling being held by the trolley on the interior track; and

FIG. 24B is an end detail view of the interior track and trolley being hung therefrom.

Corresponding reference characters indicate corresponding parts throughout the several views. The exemplification set out herein illustrates embodiments of the narrow vehicle sling bag track system, and such exemplification is not to be construed as limiting the scope of the narrow vehicle sling bag track system in any manner.

### DETAILED DESCRIPTION OF THE DRAWINGS

The figures and descriptions provided herein may have been simplified to illustrate aspects that are relevant for a clear understanding of the herein described devices, systems, and methods, while eliminating for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The present disclosure provides a narrow vehicle sling bag track system that provides for a laundry bag or other articles to be both extended and suspended from the exterior of the cargo area of the delivery vehicle. In particular, the narrow vehicle sling bag track system is configured to extend through narrower cargo area doors that occupy only a portion of the rear of sidewall of the vehicle's cargo area. In an illustrative embodiment, the track system is able to extend a track through the narrower door opening of the cargo area despite that door opening not extending appreciably the entire width of the end or side of the cargo area of the vehicle. In a further illustrative embodiment, the cargo area of the vehicle may have an end or side wall panel located adjacent a door opening where both of which form at least a portion of a side of the cargo area of the vehicle. In an illustrative embodiment, a track may be extended from that door opening at an angle that is non-orthogonal, coaxial, or parallel, to a portion of the track system located inside the cargo area of the delivery vehicle. In a further illustrative embodiment, the track arm may be detachable from the narrow vehicle sling bag track system located inside the cargo area of the vehicle. To that end, the narrow vehicle sling bag track system is adapted to extend from the door opening of the cargo area of the vehicle despite the presence of both doors and sidewall sections occupying a side of the cargo area.

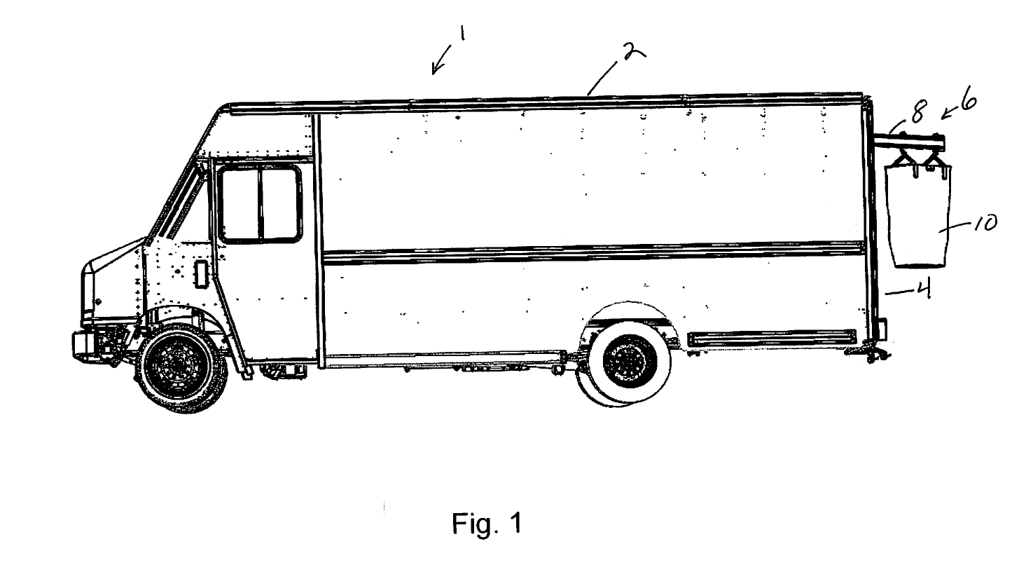

A side view of delivery vehicle 1, with a laundry sling bag 10 suspended from track 8 from the illustrative rear 4 of cargo area 2, is shown in FIG. 1. From this view, the utility of sling back track system 6 is apparent where sling bag 10 and its contents are able to extend and suspend from track 8 to the exterior of cargo area 2 of delivery vehicle 1—not unlike the embodiments shown in FIG. 1 of the '656 patent.

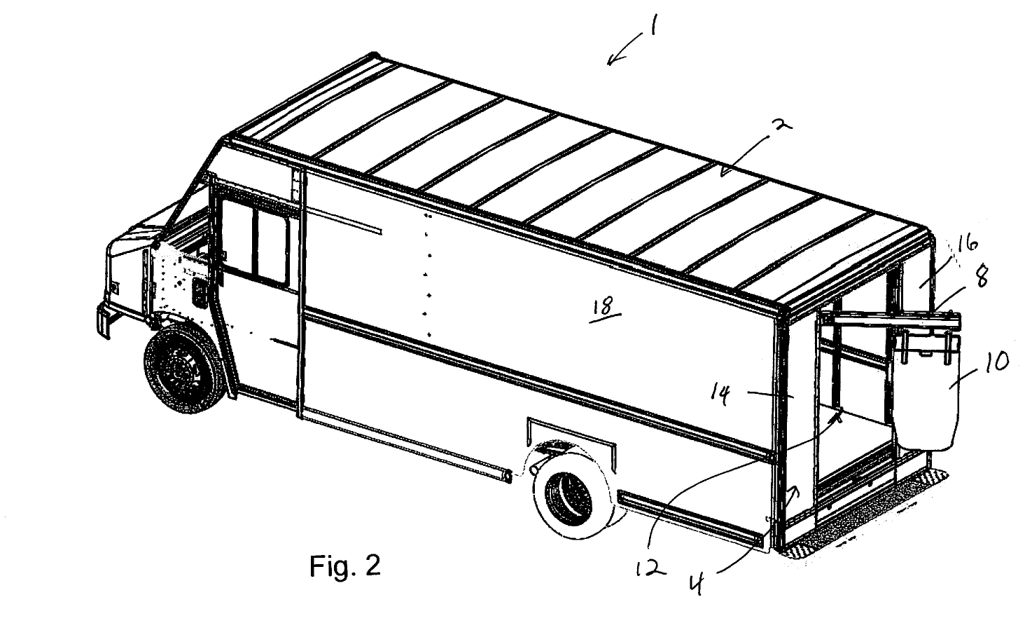

A rear-perspective view of cargo area 2 of vehicle 1 is shown in FIG. 2. This view depicts, in contrast, how track 8 extends through a relatively narrow cargo area opening 12 that is flanked on both sides by rear wall portions 14 and 16, as illustratively shown. Cargo area opening 12 is, therefore, narrower than the comparable area shown in delivery vehicle 1 of the '656 patent.

As further shown in this view, track 8 is oriented at a skewed angle from the longitudinal extent of side wall 18, avoiding rear wall portion 14, and extending outward through cargo area opening 12. This arrangement creates the offset angle of track 8 with respect to side wall 18. Because other delivery trucks include rear openings that extend almost the entire width of the truck, their stationary and extending rail components are oriented essentially parallel to each other. This is not the case in the present disclosure. As such, outwardly extending track 8 extends from the rear of delivery vehicle 1, and is placed at a non-parallel angle due to the comparably narrower cargo area opening 12.

As such, an illustrative embodiment of the present disclosure provides a sling bag track system where sling bag 10 may still be aligned along a track adjacent to and parallel with side wall 18, but can be moved onto track 8 through narrow cargo area opening 12 for handling exterior of vehicle 1. Unlike prior embodiments, each sling bag 10 does not transfer from one track or rod and engage another parallel-extending rod that then extends the exterior of the vehicle. In this case, sling bag 10 transfers to a track that is nonparallel to the wall hanging track in order to move sling bag 10 exterior of vehicle 1.

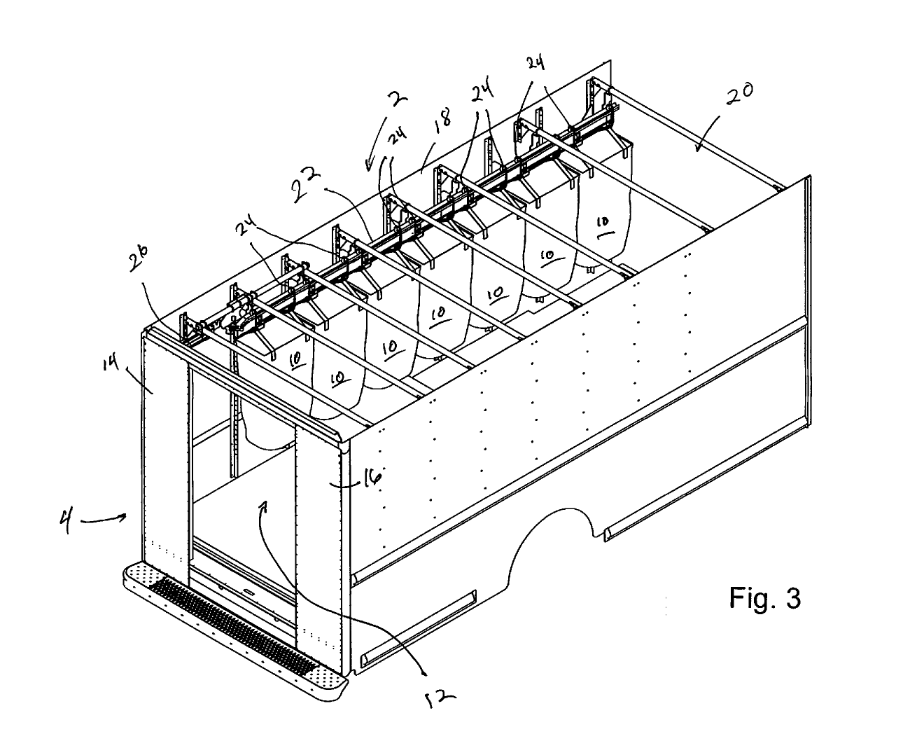

Rear perspective views of cargo area 2 having the roof removed so interior 20 of cargo area 2 is visible, along with cargo area opening 12, with doors removed for demonstrative purposes, are shown in FIGS. 3 through 8. These views depict a progression regarding how sling bag track system 6 operates. With respect to the perspective view of cargo area 2 shown in FIG. 3, it depicts a plurality of sling bags 10 suspended from an interior track 22 by trolleys 24 inside interior 20 adjacent side wall 18. This is illustrative of how the plurality of sling bags 10, filled with laundry, may be stored in interior 20 of cargo area 2, while being transported from one location to another. At this stage, there is no mechanism for the sling bags 10 to be removed to the exterior of cargo area 2. It will be appreciated nonetheless from this view how such organization saves substantial space inside interior 20 of cargo area 2. Also shown in this view is pivot arm 26, which will be used to couple track 8 to interior track 22 to move the plurality of sling bags 10 out of cargo area 2. In this view, however, pivot arm 26 is located in its stowed position and not attached to track 8.

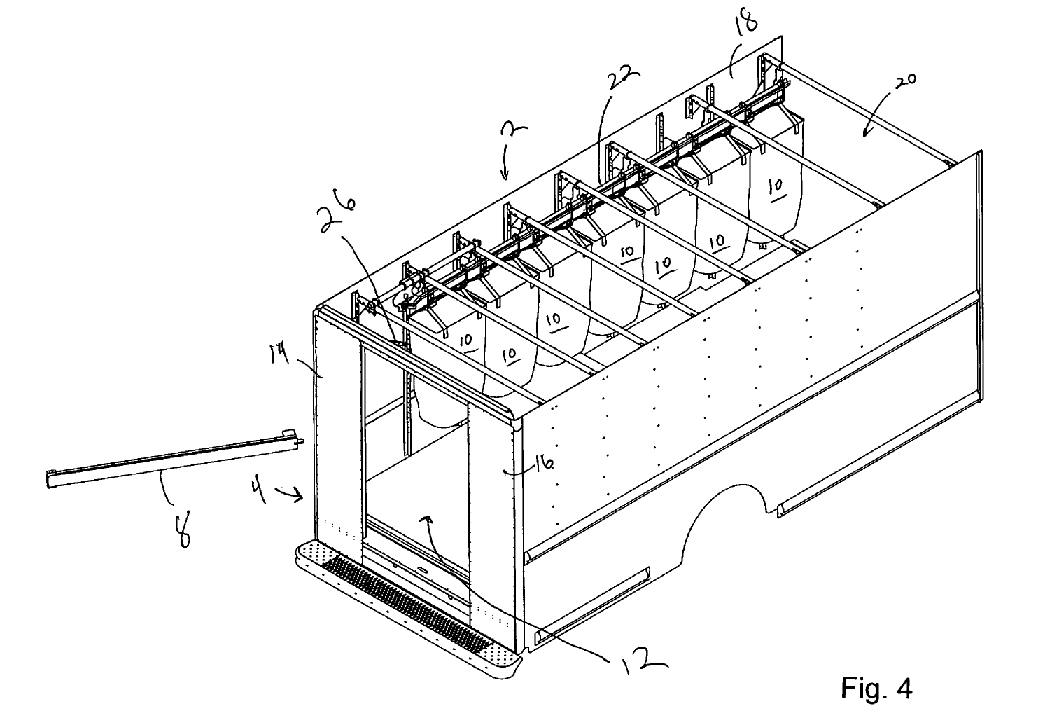

Another rear perspective view of cargo area 2, similar to that shown in FIG. 3, is shown in FIG. 4. This view differs from FIG. 3 in that track 8 is introduced and pivot arm 26 is moved towards cargo area opening 12. It is contemplated that track 8 may be stowed in interior 20 of cargo area 2 or may be kept separate from delivery vehicle 1. For example, when delivery vehicle 1 reaches a cleaning facility, track 8 may be stored at the cleaning facility and brought to cargo area opening 12.

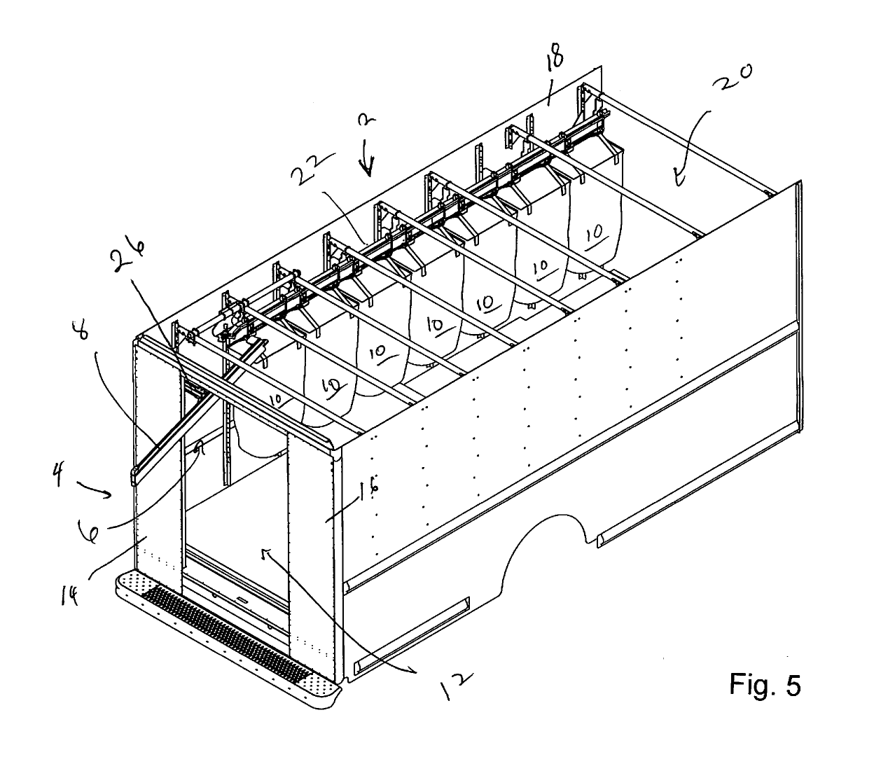

The perspective view of cargo area 2, shown in FIG. 5, is similar to the views in FIGS. 3 and 4. FIG. 5, however, further depicts the progression of attaching track 8 to interior track 22 in interior 20 of cargo area 2. Here, track 8 is disposed through cargo area opening 12 and is attached to pivot arm 26. It is not yet, however, attached to interior track 22.

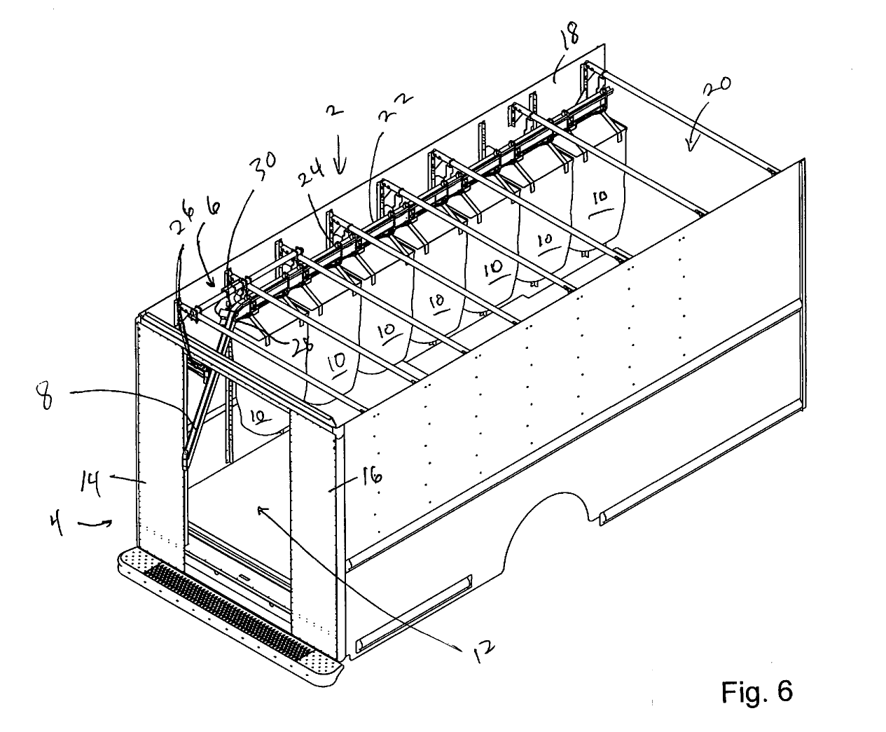

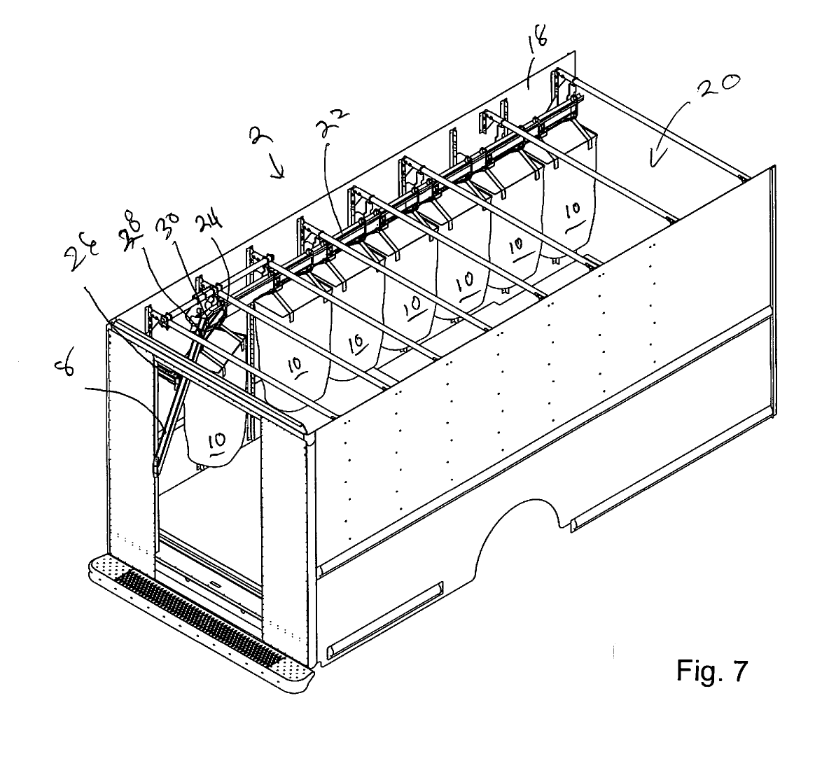

The perspective view of cargo area 2 shown in FIG. 6 is similar to that shown in FIGS. 3, 4, and 5. FIG. 6, however, furthers the progression of assembling sling bag track system 6 by coupling track end 28 of track 8 to track end 30 of interior track 22. To that end, track 8 is now supported by at least two locations (i.e., pivot arm 26, and interior track 22). As such, interior track 22 is aligned with track 8 to allow sling bags 10, suspended by trolleys 24, to roll along interior track 22 and track 8 to move sling bags 10 to exterior of cargo area 2. And as shown in the perspective view of cargo area 2 in FIG. 7, sling bags 10 are each suspended by trolley 24 are shown moving between tracks 8 and 22 at track ends 28 and 30, respectively. This demonstrates the orderly movement possible for each sling bag 10 out of interior 20 of cargo area 2.

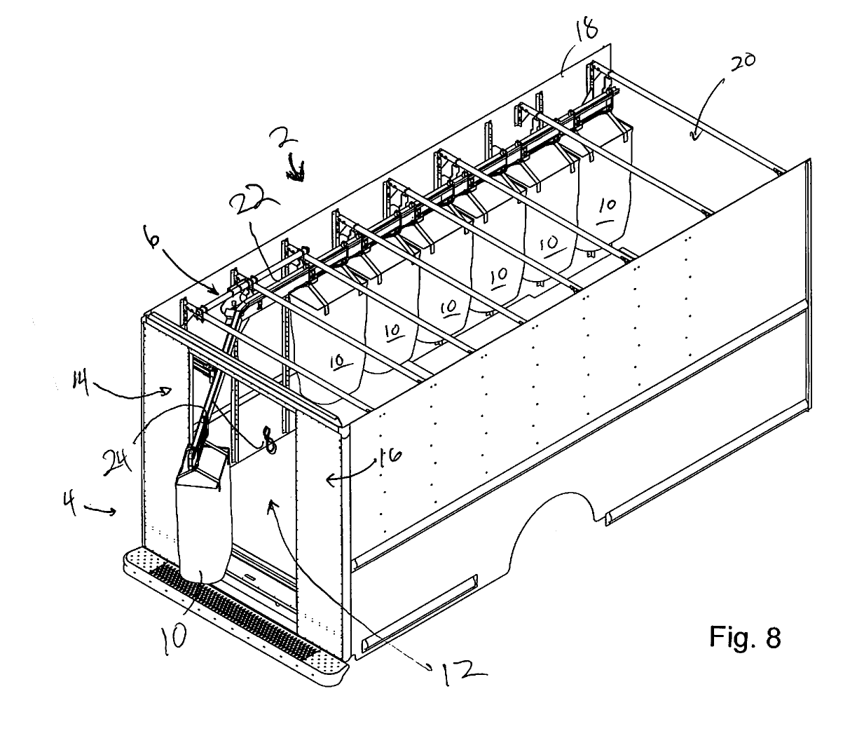

Lastly, as shown in the perspective view of cargo area 2 in FIG. 8, the utility of sling bag track system 6 is demonstrated by sling bag 10 suspended on trolley 24 being moved along track 8 from interior track 22 through cargo area opening 12 to the exterior of cargo area 2. Again, FIGS. 3 through 8 demonstrate how sling bag track system 6 assembles and operates to move sling bags 10 from the interior 20 of cargo area 2 to the exterior of same.

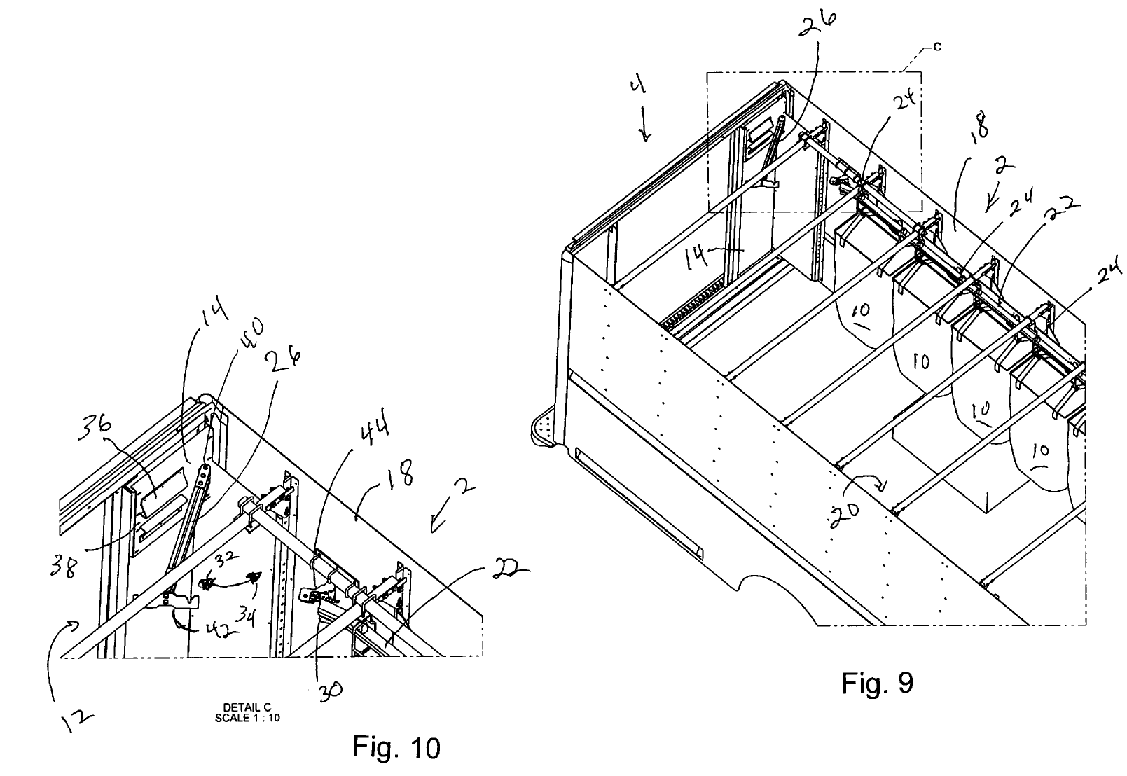

A top perspective view of cargo area 2, with the roof removed and looking towards rear 4, is shown in FIG. 9. This view first depicts how sling bags 10 are illustratively aligned on interior track 22, which is attached to side wall 18 in interior 20 of cargo area 2. Again, in this illustrative embodiment, sling bags 10 are each suspended from interior track 22 by attached trolleys 24. This view also shows pivot arm 26 located adjacent rear wall portion 14 and side wall 18, being pivotable with respect to both.

As shown in the detail view of FIG. 10, pivot arm 26 is illustratively attached to rear wall portion 14. That said, pivot arm 26 may alternatively be attached to side wall 18 as needed. Pivot arm 26 is configured to pivot in directions 32 and 34, to either use or stowed positions. In the illustrated embodiment, a receiver 36, including a clamp 38, may be attached to rear wall portion 14. Pivot arm 26 may be pivoted in direction 32 and fitted within clamp 38 to hold pivot arm 26 in place at its use position. While not in use, pivot arm 26 may be moved out of clamp 38 and out of the way against side wall 18.

Pivot arm 26 may also include a pivot bracket 40 that may be attached to either rear wall portion 14 or side wall 18 and pivot back and forth with respect thereto. It will be appreciated by the skilled artisan, upon reading this disclosure, that any type of pivot bracket that includes a wall mount that engages at least a pivot pin, which engages pivot arm 26, may be used as a pivoting means for pivot arm 26.

Illustratively, located opposite pivot bracket 40, is an attachment bracket 42. As further shown in FIG. 13, for example, attachment bracket 42 may selectively secure to track 8 to suspend same while being disposed through cargo opening 12. Because attachment bracket 42 pivotally attaches to track 8, pivot arm 26 provides flexibility as to the angle at which track 8 will be held with respect to vehicle 1. Indeed, in alternate embodiments, attachment bracket 42 may be attached to pivot arm 26 via alternate pivot bracket structures, which allow attachment bracket 42 to pivot independently of pivot arm 26. Also shown in this view is a rotary latch assembly 44, extending adjacent track end 30 of interior track 22. Rotary latch assembly 44 provides a second point of attachment for track 8 to keep it suspended inside interior 20 of cargo area 2. Alternatives for the rotary latch may include, but is not limited to cam latches, draw latches, toggle clamps, and spring plungers, for example.

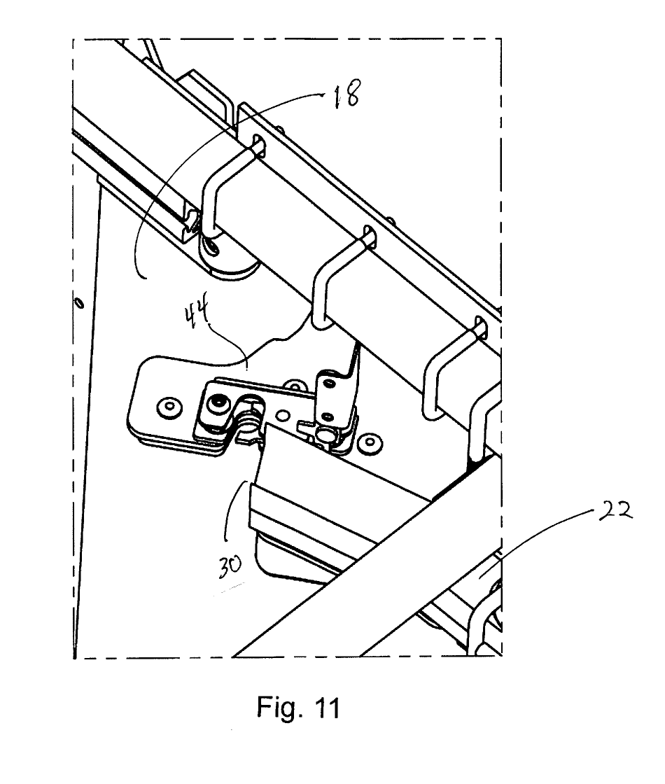

A detail perspective view of track end 30 of interior track 22 is shown in FIG. 11. This view shows more detail of rotary latch assembly 44. It will be appreciated by the skilled artisan, upon reading this disclosure, that any type of suitable rotary or other latching mechanism may be used adjacent track end 30 of interior track 22. Rotary latch assembly 44 is employed, so it can selectively attach and detach track 8 from track end 30. As will be further discussed herein, it may be useful for track end 30 of interior track 22 to abut track end 28 of track 8 to provide a continuous pathway from interior track 22 to track 8 for the plurality of sling bag 10 to travel along.

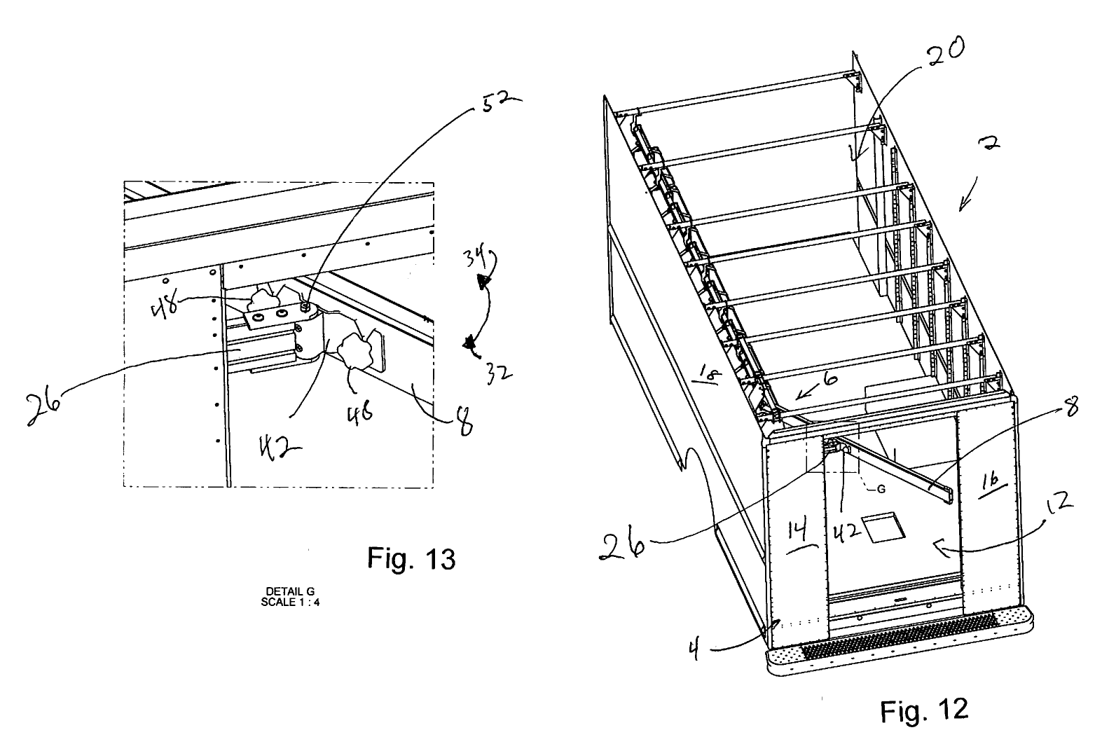

A rear perspective view of cargo area 2, with the roof and doors removed showing interior 20 and cargo area opening 12, is shown in FIG. 12. This view also shows track 8 attached to attachment bracket 42 of pivot arm 26 to support track 8 to the exterior of cargo area 2 as illustratively shown. Track 8 is extended to the exterior of cargo area 2 at an angle transverse to the plane formed by side wall 18 so track 8 avoids rear wall portion 14, but still extends exterior of cargo area 2.

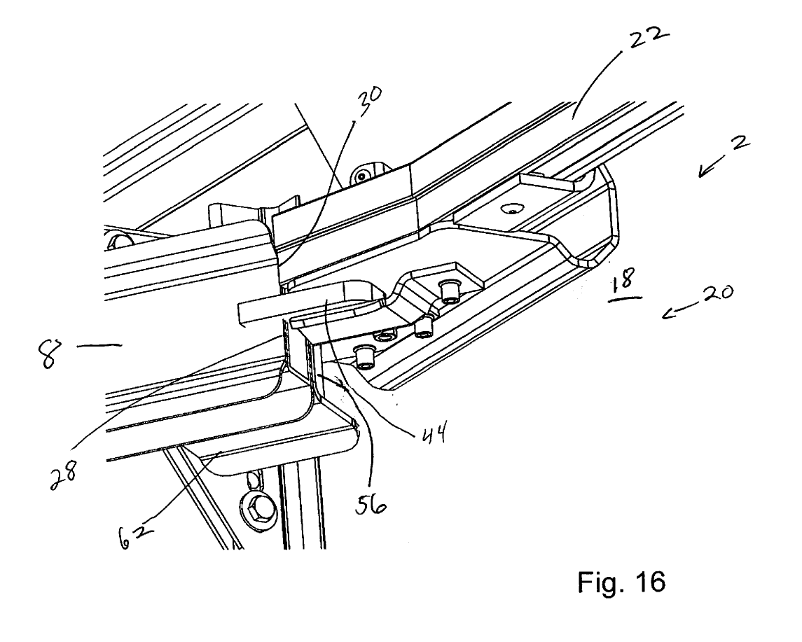

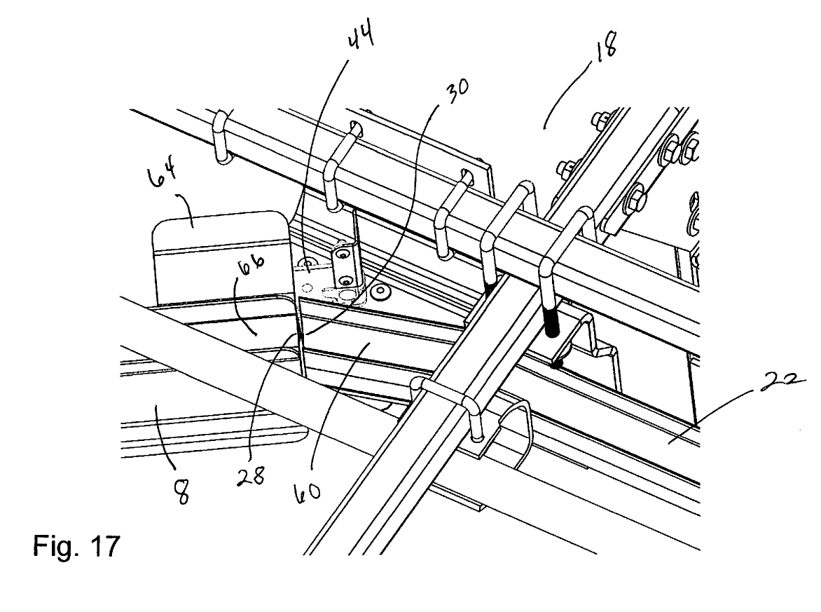

A detail view of a portion of track 8 and pivot arm 26 from FIG. 12 is shown in FIG. 13. Here, illustrative thumbscrews 48 serve as fasteners that connect attachment bracket 42 to track 8. Illustratively, attachment bracket 42 attaches to pivot arm 26 via pivot pin 52 disposed through both pivot arm 26 and attachment bracket 42. This allows attachment bracket 42, and thus track 8, to be pivotable in directions 32 or 34. This allows track 8 to more easily pivot to rotary latch assembly 44 and attach thereto (see, also, FIGS. 16 and 17). Illustratively, thumbscrews 48 each include a fastener that secures attachment bracket 42 to track 8. Thumbscrews are illustratively used to allow hand tightening. Accordingly, assembly and disassembly of track 8 from the rest of sling bag track system 6 is convenient and does not require additional tools.

It is appreciated that, as a method of assembling sling bag track system 6, attaching track 8 to attachment bracket 42 is an early, if not first, step. It is further appreciated that the means by which track 8 is attached to attachment bracket 42 can vary. For example, attachment bracket 42 may include extending tabs that could fit into corresponding slots at predetermined locations along track 8. Conversely, the tabs may be located on track 8 and the slots located in attachment bracket 42. In another illustrative embodiment, pins may be used to be disposed through both attachment bracket 42 and track 8, for example, and simply pulled out when disconnecting the two structures. It is further appreciated that other like mechanical structures that can removably attach track 8 to attachment bracket 42 are contemplated.

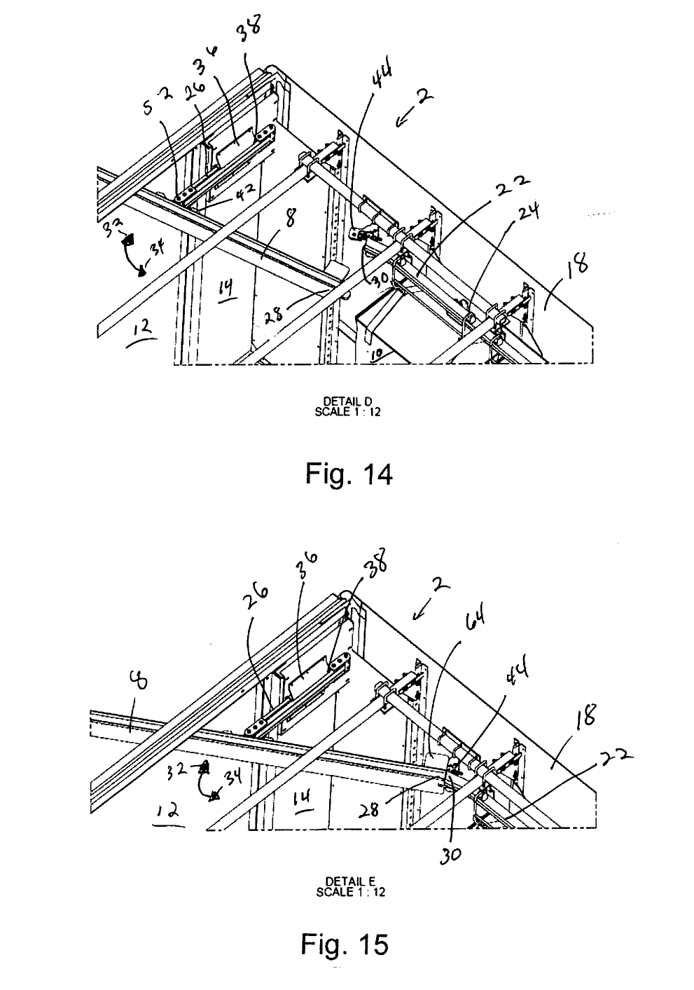

A perspective interior view of cargo area 2, with the roof removed, is shown in FIG. 14. This view shows pivot arm 26 attached to track 8 and fitted in clamp 38 of receiver 36. Here, pivot arm 26 may be held stationary once attached to track 8 against rear wall portion 14. Because of pivot pin 52, as discussed with respect FIG. 13, track 8 may still pivot in directions 32 and 34, but pivot arm 26 itself may be selectively prevented from pivoting. This may be useful to more easily attach track end 28 of track 8 to track end 30 of interior track 22. More particularly, this allows pin 56 or other like structures (see, also, FIG. 16) at track end 28 of track 8 to engage rotary latch assembly 44 located adjacent track end 30 of interior track 22.

As shown in a similar view of cargo area 2, in FIG. 15, track 8 has been pivoted illustratively in direction 34 until track end 28 engages rotary latch assembly 44. The skilled artisan upon reading the present disclosure will appreciate that, by attaching track 8 to attachment bracket 42, and attaching pivot arm 26 into clamp 38 of receiver 36, restricts track 8 from moving except in directions 32 or 34. Here, to attach track 8 to interior track 22, track 8 only needs to pivot in direction 34 until track end 28 engages rotary latch assembly 44.

An underside perspective detail view of interior 20, of cargo area 2, is shown in FIG. 16. Particularly, this view depicts how interior track 22 couples to track 8. In this case, a pin 56 extends illustratively vertical between bracket members 62 and 64 (see, also, FIGS. 15, 17, and 18) spaced apart from track end 28 of track 8. This makes pin 56 spaced apart and illustratively vertically oriented from track end 28 and available to engage rotary latch assembly 44, which is known to attach to such pins. It will be appreciated by the skilled artisan that the location of pivot pin 56 is positioned so that track end 28 of track 8 will abut track end 30 of interior track 22.

As particularly shown in FIG. 17, end 30 of interior track 22 is open and configured to abut track end 28 of track 8 such that pathway 60, on interior track 22, is in communication with pathway 66 on track 8, to create a continuous pathway along the lengths of track 22 and track 8. This will allow the sling bag 10 to roll along tracks 22 and 8 track to exterior of cargo area 2.

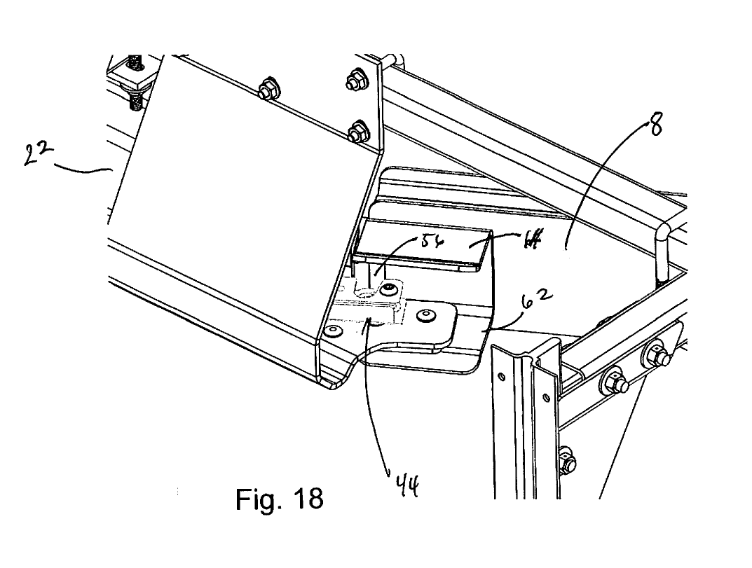

A reverse perspective detail view of rotary latch assembly 44 located adjacent pin 56 is shown in FIG. 18. Bracket members 62 and 64 are attached to track 8 and hold pin 56 as illustratively shown. Rotary latch assembly 44 receives pin 56 to secure track 8 to track 22 to hold track 8 in place.

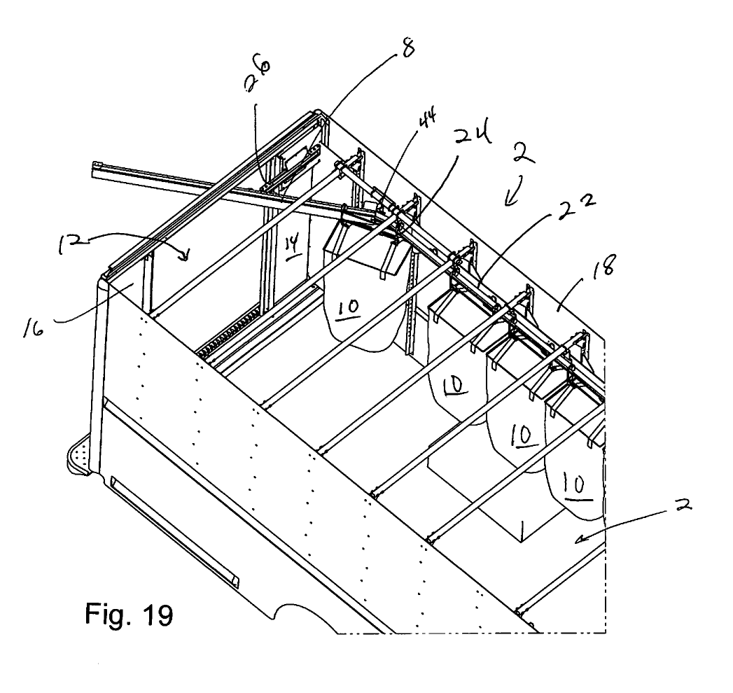

As shown in the perspective view of cargo area 2, with the roof and rear doors removed in FIG. 19, sling bags 10 are suspended by trolley 24 traveling along both interior track 22 and track 8. Rollers (see, also, FIG. 24B) or other bearing members may be attached to trolley 24 in order to facilitate easier movement of sling bag 10 along tracks 22 and 8.

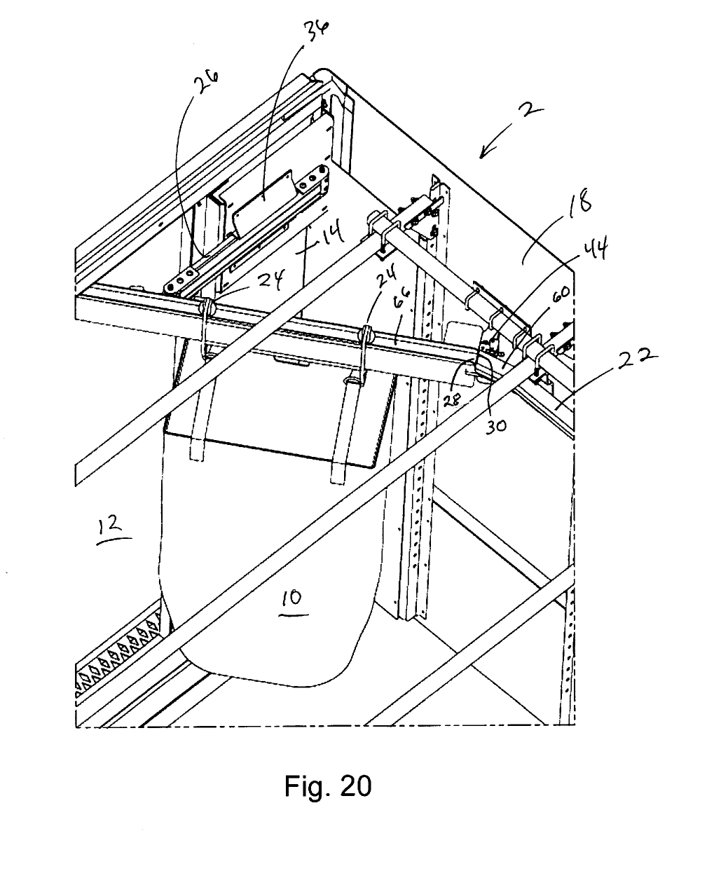

Another perspective detail interior view of cargo area 2 is shown in FIG. 20. Here, trolley 24 suspends sling bag 10 allowing it to be moved from interior track 22 and onto track 8 towards rear cargo area opening 12. Because tracks 8 and 22 create a continuous pathway due to connecting track ends 28 and 30, sling bag 10 has the ability to conveniently move from interior 20 of cargo area 2 to the exterior of cargo area 2.

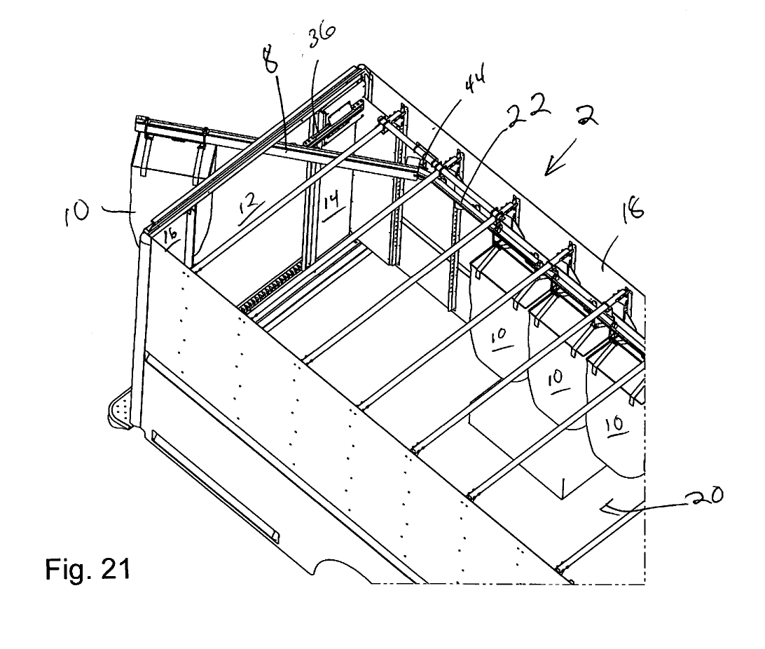

The perspective view of interior 20 of cargo area 2, with the roof and rear doors removed in FIG. 21, shows sling bags 10 moved along track 8 from track 22 to the exterior of cargo area 2. At this point, sling bags 10 are available for removal or processing exterior of cargo area 2. It is appreciated that additional sling bags 10 may be slid down tracks 22 and 8 in the same manner as needed to be positioned exterior of cargo area 2 as well.

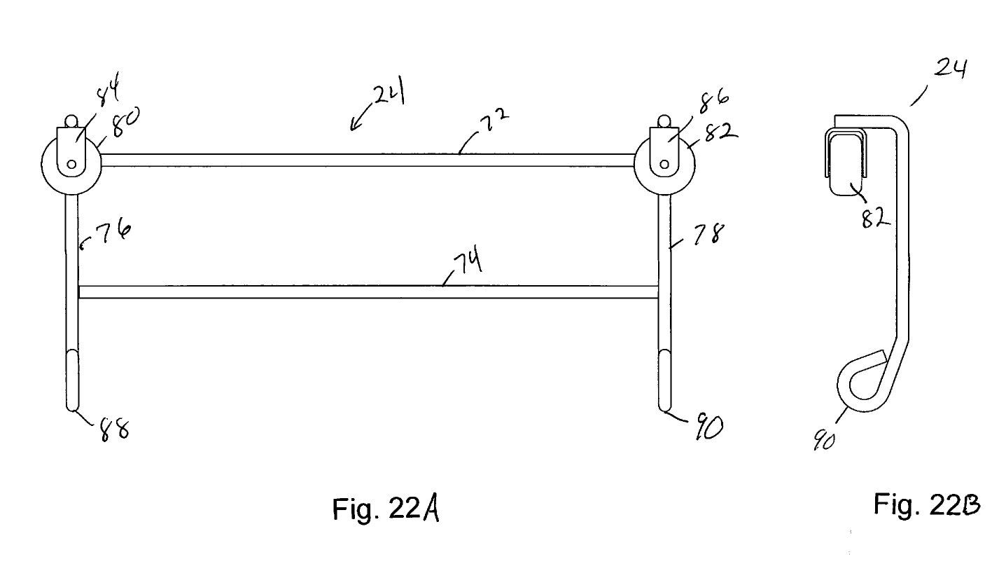

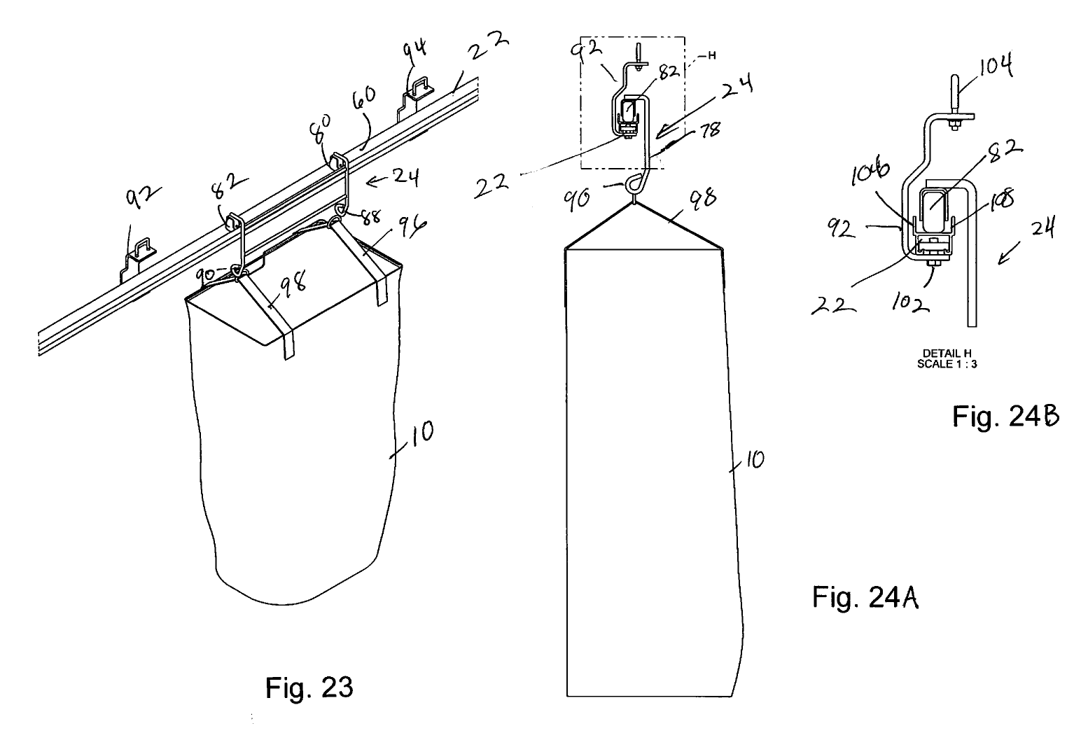

Front and side views of trolley 24 are shown in FIGS. 22A and 22B, respectively. The view in FIG. 22A depicts braces 72 and 74 spaced apart and spanned between hanger portions 76 and 78 as illustratively shown. Rollers 80 and 82 are suspended on hanger portions 76 and 78, respectively, via brackets 84 and 86, respectively, as illustratively shown. Rollers 80 and 82 are suspended from hanger portions 76 and 78 to engage interior track 22 (see, also, FIGS. 23 and 24A and 24B). Hanger loops 88, and 90 of hanger portions 76 and 78, respectively, connect to sling bag 10.

A perspective isolated view of sling bag 10, hanging from interior track 22, is shown in FIG. 23. This view depicts rollers 80 and 82 seated on pathway 60 of interior track 22. In addition, brackets 92 and 94, for example, are configured to suspend interior track 22 in interior 20 of cargo area 2. It is appreciated that other bracket designs may be employed in order to suspend interior tract 22 in a desired location within cargo area 2 and be within the scope of this disclosure. Sling bag 10 is shown suspended from hanger loops 88 and 90 via straps 96 and 98, respectively. By suspending from trolley 24, sling bag 10 is free to move along interior track 22 via rollers 80 and 82 from the interior to the exterior of cargo area 2.

An end view and detail end view of sling bag 10, being held by trolley 24 on interior track 22, are shown in FIGS. 24A and 24B, respectively. As depicted in FIG. 24A, bracket 92 is shown suspending interior track 22 that receives roller 82 of trolley 24 holding sling bag 10 via straps 98. As shown in the detail view of FIG. 24B, interior track 22 is illustratively fastened to bracket 92 via illustrative fastener 102. A loop 104, at the top of bracket 92, is configured to attach to cross braces in interior 20 of cargo area 2 to suspend interior track 22 therein. Illustratively, sidewalls 106 and 108 extend from interior track 22 to provide guidance for roller 82, as well as other rollers from other trolleys 24, as previously shown, to keep the same on interior track 22.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. It should also be appreciated that any subject matter disclosed in this non-provisional Patent Application that may differ from the priority Application, the disclosure from this non-provisional Patent Application controls.

What is claimed is:

1. A cargo vehicle comprising:
a cargo area that includes an internal surface;
a rail assembly attached to the internal surface;
a movable rail assembly selectively attachable to the rail assembly that is attached to the internal surface of the cargo area;
wherein the movable rail assembly includes an elongated track arm and a pivot arm;
wherein the pivot arm is attached to the cargo area and selectively attachable to the elongated track; and
a latch assembly that selectively couples to the elongated track arm of the movable rail assembly;
wherein the elongated track arm aligns with the rail assembly when the latch assembly is coupled to the elongated track arm; and
wherein the track arm is extendable from interior of the cargo area to exterior of the cargo area.

2. The cargo vehicle of claim 1, wherein the elongated track arm is aligned with rail assembly at a nonlinear angle with respect to the rail assembly.

3. The cargo vehicle of claim 1, wherein the pivot arm is attachable to a second internal surface of the cargo area.

4. The cargo vehicle of claim 3, wherein the pivot arm is pivotally attached to the second internal surface of the cargo area.

5. The cargo vehicle of claim 1, wherein the pivot arm is pivotally attached to the elongated track arm.

6. The cargo vehicle of claim 1, further comprising a receiver that selectively holds the pivot arm.

7. The cargo vehicle of claim 4, further comprising a receiver attached to the second internal surface of the cargo area, wherein the receiver selectively holds the pivot arm adjacent the second internal surface of the cargo area.

8. The cargo vehicle of claim 1, wherein the pivot arm includes a bracket that selectively attaches to the elongated track arm.

9. The cargo vehicle of claim 1, wherein the latch assembly includes a rotary latch that selectively engages a pin located on the elongated track arm to align the rail assembly with the elongated track arm.

10. The cargo vehicle of claim 9, wherein the elongated track arm includes a bracket that holds the pin.

11. The cargo vehicle of claim 1, wherein the cargo area includes an opening, wherein the opening is located between the interior of the cargo area and the exterior of the cargo area, and wherein the elongated track arm is extendable through the opening from the interior of the cargo area to the exterior of the cargo area.

12. The cargo vehicle of claim 1, further comprising a sling bag that is suspendable on the rail assembly and movable along the interior track assembly from the interior of the cargo area to the exterior of the cargo area.

13. A cargo vehicle comprising:
a cargo area;
a rail assembly located in the cargo area;
a movable rail assembly selectively attachable to the rail assembly in the cargo area;
wherein the movable rail assembly includes an elongated track arm;
a latch assembly that selectively couples to the elongated track arm;
wherein the elongated track arm aligns with the rail assembly when the latch assembly is coupled to the elongated track arm.

14. The cargo vehicle of claim 13, wherein the track arm is extendable from interior of the cargo area to exterior of the cargo area.

15. The cargo vehicle of claim 13, wherein the cargo area includes a first wall wherein the rail assembly is attached to the first wall.

16. The cargo vehicle of claim 13, further comprising a pivot arm selectively attachable to the elongated track.

17. The cargo vehicle of claim 16, wherein the pivot arm is pivotally attached to a second wall of the cargo area and pivotally and selectively attachable to the elongated track.

18. The cargo vehicle of claim 17, further comprising a receiver attached to the second wall of the cargo area, wherein the receiver selectively holds the pivot arm adjacent the second wall of the cargo area.

19. The cargo vehicle of claim 13, wherein the elongated track arm is aligned with rail assembly at a nonlinear angle with respect to the rail assembly.

20. A method of assembling a sling bag track system for a cargo vehicle, the method comprising the steps of:
providing a cargo area portion of the cargo vehicle, wherein the cargo area including a first wall with a rail assembly attached to the first wall, a pivot arm located within the cargo area and pivotable with respect to the first wall, a latch assembly located adjacent the rail assembly, and a second wall with an opening disposed through the second wall;
inserting an elongated track arm through the opening disposed through the second wall;
attaching the elongated track arm to the pivot arm;
attaching the elongated track arm to the latch assembly; and
extending the elongated track arm from interior of the cargo area to exterior of the cargo area.
